(19) United States
(12) Patent Application Publication
(10) Pub. No.: US 2013/0300978 A1
(43) Pub. Date: Nov. 14, 2013

(54) Display with Minimized Light Leakage

(71) Applicant: APPLE INC., Cupertino, CA (US)

(72) Inventors: Young Cheol Yang, Sunnyvale, CA (US); Cheng Chen, San Jose, CA (US); Charley T. Ogata, San Jose, CA (US)

(73) Assignee: Apple Inc., Cupertino, CA (US)

(21) Appl. No.: 13/630,960

(22) Filed: Sep. 28, 2012

Related U.S. Application Data
(60) Provisional application No. 61/646,867, filed on May 14, 2012.

(51) Int. Cl. G02F 1/1335; G02F 1/13357

(52) U.S. Cl. 349/62; 349/106; 349/96

(57) ABSTRACT

Displays such as liquid crystal displays may be provided with transparent substrates that minimize light leakage from the display. The transparent substrates may include a thin-film transistor substrate having thin-film transistors formed on a surface of the thin-film transistor substrate and a color filter substrate having color filter elements formed on a surface of the color filter substrate. The thin-film transistor substrate may be formed from a material having a relatively low photo-elastic constant. The color filter substrate may be formed from a material having a relatively low photo-elastic constant. Reduced birefringence effects in the thin-film transistor substrate and the color filter substrate may help minimize light leakage from the display when some or all of the display experiences internal or external stresses.

This application claims the benefit of provisional patent application No. 61/646,867, filed May 14, 2012, which is hereby incorporated by reference herein in its entirety.

### BACKGROUND

This relates generally to displays, and, more particularly, to displays such as liquid crystal displays.

Displays are widely used in electronic devices to display images. Displays such as liquid crystal displays display images by controlling liquid crystal material in the display using electrodes associated with an array of image pixels. In a typical liquid crystal display, the liquid crystal material is formed between a glass layer with an array of thin-film transistor circuits and a glass layer with an array of color filter elements.

Portions of a liquid crystal display often experience stresses due to mounting structures that are attached to the display or due to internal display structures. During operation of a conventional liquid crystal display, the liquid crystal material is sometimes arranged so that light is blocked from escaping from the display. However, in a portion of the display that is under stress, a fraction of that light can sometimes escape from that portion of the display or from a nearby portion of the display. This type of light leakage from a display under stress can create difficulties in, for example, displaying images with dark portions.

It would therefore be desirable to be able to provide improved displays such as displays that exhibit minimized light leakage under stress.

### SUMMARY

Displays such as liquid crystal displays may have upper and lower polarizers. A display may have a color filter (CF) layer and a thin-film transistor (TFT) layer. The color filter layer and the thin-film transistor layer may be formed on respective transparent substrates such as rigid transparent substrates that are located between the upper and lower polarizers.

A liquid crystal layer may be interposed between the color filter layer substrate and the thin-film transistor layer substrate. Thin-film transistors on the thin-film transistor substrate and transparent electrodes may be used in applying patterns of electric fields to the liquid crystal layer.

The color filter layer may include color filter elements formed on the transparent color filter substrate. The color filter substrate and the thin-film transistor substrate may be formed from materials such as glass, plastic, a solid transparent polymer, a combination of these materials, or other transparent materials. The thin-film transistor layer may include thin-film transistors and transparent electrodes formed on the transparent thin-film transistor substrate.

The thin-film transistor substrate and/or the color filter substrate may be formed from a material having a relatively low photo-elastic constant configured to minimize light leakage when the material is stressed or flexed. Materials having a low photo-elastic constant may exhibit low amounts of birefringence when the material is under stress. Light that passes through a transparent substrate having a low photo-elastic constant may therefore experience little or no change in polarization and little or no change in direction while passing through the substrate.

Providing a display with a thin-film transistor substrate and/or a color filter substrate with a low photo-elastic constant in this way may help to minimize light leakage from the display.

Light leakage may also be minimized by reducing the thickness of the thin-film transistor substrate with respect to the thickness of the color filter substrate.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with a display such as a liquid crystal display of the type that may be provided with display substrates that reduce light leakage under stress in accordance with an embodiment of the present invention.

FIG. 2 is a cross-sectional view of a portion of an illustrative display such as a liquid crystal display showing display substrates and display layer configurations that may be used in minimizing light leakage under stress in accordance with an embodiment of the present invention.

FIG. 3 is a diagram showing how a change in polarization of light due to birefringence in a conventional glass layer may be amplified by liquid crystal retardation of the light in a conventional display substrate.

FIG. 4 is a perspective view of a portion of a display substrate having a relatively low photo-elastic constant showing how birefringence effects when the display substrate is under stress may be minimized in accordance with an embodiment of the present invention.

### DETAILED DESCRIPTION

Displays are widely used in electronic devices. For example, displays may be used in computer monitors, laptop computers, media players, cellular telephones, televisions, and other equipment. Displays may be based on plasma technology, organic-light-emitting-diode technology, liquid crystal structures, or other suitable display structures.

Liquid crystal displays are popular because they can exhibit low power consumption and good image quality. Liquid crystal display structures are sometimes described herein as an example. In order to minimize light leakage from the display when some or all of the display is under stress (e.g., when some or all of the display is experiencing an internal or external pressure or force) a liquid crystal display may be provided with one or more transparent substrate layers having a relatively low photo-elastic constant.

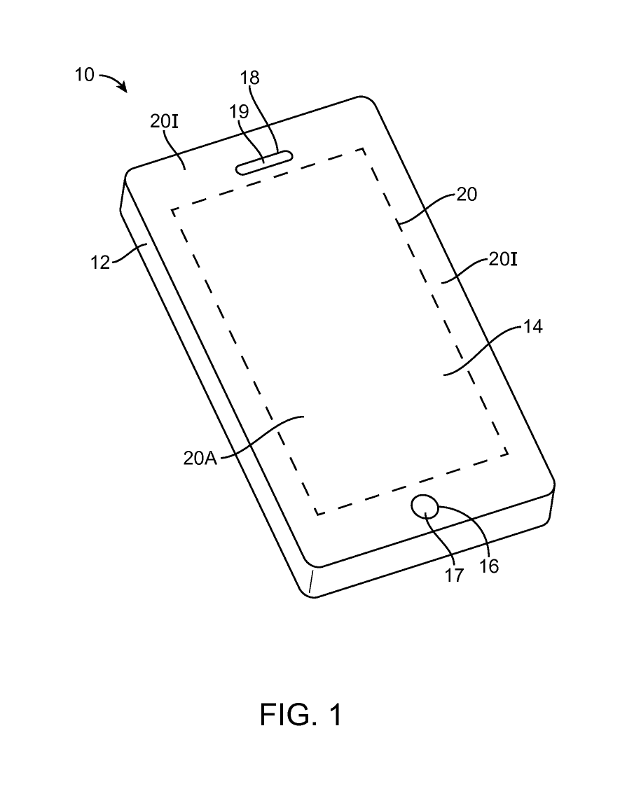

An illustrative electronic device of the type that may be provided with a liquid crystal display having transparent substrate layers with a relatively low photo-elastic constant is shown in FIG. 1. Electronic device 10 may be a portable electronic device or other suitable electronic device. For example, electronic device 10 may be a laptop computer, a tablet computer, a somewhat smaller device such as a wrist-watch device, a pendant device, or other wearable or miniature device, a cellular telephone, a media player, a display for a desktop computer, a desktop computer and a display mounted in a common package, etc.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material. In other situations, housing 12 or at least some of the structures that make up housing 12 may be formed from metal elements.

Device 10 may have a display such as liquid crystal display 14. Display 14 may be formed from multiple layers of material. These layers may include a touch sensor layer such as a layer on which a pattern of indium tin oxide (ITO) electrodes or other suitable transparent electrodes have been deposited to form a capacitive touch sensor array. Display 14 may include other display layers such as a color filter layer, a thin-film transistor layer, a layer of liquid crystal material, polarizer layers, adhesive layers, or other suitable display layers.

Display 14 may be covered by a transparent cover layer such as a cover glass layer or other rigid cover layer, the cover layer may be provided with one or more openings with electronic components mounted under the openings. For example, a transparent cover layer may have openings such as a circular opening 16 for button 17 and a speaker port opening such as speaker port opening 18 for speaker 19. Device 10 may also have other openings (e.g., openings in display 14 and/or housing 12 for accommodating volume buttons, ringer buttons, sleep buttons, and other buttons, openings for an audio jack, data port connectors, removable media slots, etc.).

In some embodiments, portions of display 14 such as peripheral regions 201 may be inactive and portions of display 14 such as rectangular central portion 20A (bounded by dashed line 20) may correspond to the active part of display 14. In active display region 20A, an array of image pixels may be used to present text and images to a user of device 10. In active region 20A, display 14 may include touch sensitive components for input and interaction with a user of device 10. If desired, regions such as regions 20I and 20A in FIG. 1 may both be provided with display pixels (e.g., all or substantially all of the entire front planar surface of a device such as device 10 may be covered with display pixels).

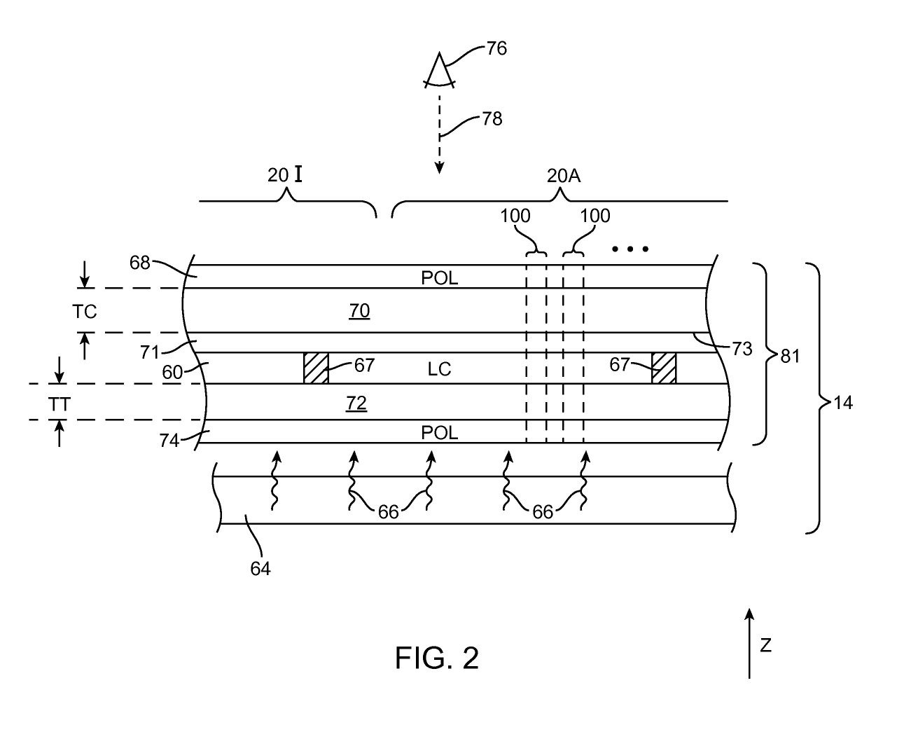

As shown in FIG. 2, display 14 may include light generating structures such as backlight structures 64. Backlight structures 64 may be used to produce backlight 66 that travels upwards (outwards) in dimension Z through display layers 81 of display 14. Display layers 81 may include an upper polarizer layer such as layer 68 and a lower polarizer layer 74.

Upper polarizer layer 68 may be attached to a transparent substrate layer such as substrate 70 (sometimes referred to as color filter substrate 70). Lower polarizer layer 74 may be attached to a transparent substrate layer such as substrate 72 (sometimes referred to herein as thin-film-transistor substrate 72).

Display 14 may have additional display layers such as layer 71 formed on interior surface 73 of layer 70. Layer 71 may include layers such as layers of color filter material, planarization layers, layers of opaque masking material, or layers that include color filter elements and opaque masking material. For example, an array of color filter elements corresponding to pixels 100 may be formed on interior surface 73 of substrate 70.

Substrate 72 of display 14 may include thin-film transistor structures of other transparent circuitry formed on an interior surface of substrate 72. Substrate 72 may also include other layers on the surface of substrate 72 such as color filter layers, layers that include thin-film transistor structures and color filter elements, planarization layers, opaque masking patterns, clear layers, or other suitable display layers.

An array of electrodes may be controlled by the thin-film transistor circuitry on the surface of thin-film transistor substrate 72. Thin-film transistor circuitry may include, as examples, amorphous silicon transistor circuitry or polysilicon transistor circuitry. Thin-film transistor circuitry may also include interconnect lines to connect electrodes formed from conductive materials such as indium tin oxide and metal to thin-film structures such as thin-film transistors. Thin-film transistor circuitry may be used in adjusting voltages to control liquid crystal material 60 in display pixels 100 in active area 20A, thereby selectively lightening and darkening pixels 100 and presenting an image to a user of device 10 such as viewer 76, viewing display 14 in direction 78.

As light 66 passes through lower polarizer 74, lower polarizer 74 polarizes light 66. As polarized light 66 passes through liquid crystal material 60, liquid crystal material 60 may rotate the polarization of light 66 by an amount that is proportional to the electric field in liquid crystal material 60. If the polarization of light 66 is aligned in parallel with the polarization of polarizer 68 in a given display pixel 100, the transmission of light 66 through layer 68 in that pixel will be maximized. If the polarization of light 66 is aligned so as to run perpendicular to the polarization of polarizer 68 in a given pixel 100, the transmission of light 66 through layer 68 will be minimized (i.e., light 66 will be blocked) in that pixel.

Backlight structures 64 may include a light source such as a light-emitting diode array for producing backlight 66. Polarizers such as polarizer 68 and polarizer 74 may be formed from thin polymer films. For example, polarizer 68 may be formed from polymer film and an associated adhesive layer such as optically clear adhesive layer.

If desired, display 14 may be provided with layers for reducing fingerprints (e.g., a smudge-resistant coating in a touch-sensitive display), anti-scratch coatings, an antireflection coating, a layer for reducing the impact of static electricity such as an indium tin oxide electrostatic discharge protection layer, or other layers of material.

Portions of display 14 may experience stresses (e.g., pulling, flexing, stretching, warping, or compressing forces) from internal or external structures. For example, display 14 may be mounted in housing 12 such that housing 12 or mounting structures for mounting display 14 to housing 12 compress a portion such as a corner or an edge of display 14. As other examples, internal structures such as spacers 67 in liquid crystal layer 60 may generate local forces (stresses) on nearby portions of display 14 or laminated layers such as polarizers 68 and/or 74 may have an intrinsic shape that, when mounted to substrates 70 and/or 72 respectively generate pulling forces on portions of substrates 70 and/or 72.

Substrates 70 and/or 72 may be formed from transparent materials such as glass, plastic, or other materials having a relatively low photo-elastic constant configured to minimize light leakage from display 14 when some or all of display 14 is stressed or flexed.

The photo-elastic constant of a substrate is a constant that relates the amount of change in the index of refraction of a substrate to an amount of stress on the substrate. For example, in the following equation, C may be the photo-elastic constant of a substrate:

nₑ−nₒ=C(σₙ−σ₂₂) (1)

where nₑ and nₒ represent indices of refraction and σₙ and σ₂₂ represent perpendicular stresses on the substrate. Indices of refraction nₑ and nₒ are commonly referred to as indices of refraction of an “extraordinary” and an “ordinary” component of the light that is refracted through a substrate. Light having a polarization that is perpendicular to the optical axis of the substrate will be refracted based on the ordinary index refraction nₒ, while light having a polarization parallel to the optical axis of the substrate will refract at an “extraordinary” angle that can be computed using the extraordinary index of refraction nₑ.

As shown in equation 1, photo-elastic constant C represents the proportionality between a perpendicular stress difference on a substrate and the resulting induced difference between two indices of refraction in the substrate. In situations in which there is no stress, no extraordinary component will result, regardless of the size of the photo-elastic constant. In situations in which there is equal stress in perpendicular directions, no extraordinary component will result, regardless of the size of the photo-elastic constant. However, birefringence effects in a display may be minimized, regardless of the stresses on the substrate, by providing the display with a substrate with a low photo-elastic constant.

As examples, substrates 70 and/or 72 may have a photo-elastic constant of less than 3.0×10⁻¹³ cm²/dyn, less than 2.0×10⁻¹³ cm²/dyn, less than 1.0×10⁻¹³ cm²/dyn, less than 0.5×10⁻¹³ cm²/dyn, less than 0.3×10⁻¹³ cm²/dyn, less than 0.2×10⁻¹³ cm²/dyn, between 0.1×10⁻¹³ cm²/dyn and 0.3×10⁻¹³ cm²/dyn, between 0.05×10⁻¹³ cm²/dyn and 0.3×10⁻¹³ cm²/dyn, between 0.05×10⁻¹³ cm²/dyn and 0.5×10⁻¹³ cm²/dyn or between 0.09×10⁻¹³ cm²/dyn and 0.3×10⁻¹³ cm²/dyn.

Light leakage from display 14 when display 14 is under stress may also be reduced by providing display 14 with a thin-film transistor substrate such as substrate 72 having a reduced thickness TT. This is because light retardation in thin-film transistor substrate is proportional to the photo-elastic constant, the perpendicular stress difference (e.g., σ₁₁−σ₂₂), and the thickness TT of the substrate. For example, thickness TT may be substantially less than thickness TC of color filter glass 70. Thickness TT may, as examples, be between 0.1 mm and 0.2 mm, between 0.05 mm and 0.15 mm, between 0.2 mm and 0.3 mm or less than 0.3 mm. Thickness TC may, as examples, be between 0.4 mm and 0.5 mm, between 0.35 mm and 0.55 mm, between 0.3 mm and 0.4 mm or greater than 0.3 mm.

It has been discovered that, in some situations, light leakage from a liquid crystal display that is under stress may not be strongly dependent on effects of the stress on the liquid crystal material itself. It has been observed that light leakage from a display having polarizers attached to transparent display substrates having relatively high photo-elastic constants (i.e., greater than 3.0×10⁻¹³ cm²/day) can actually increase in the absence of intervening liquid crystal (or upon isotropization of the liquid crystals).

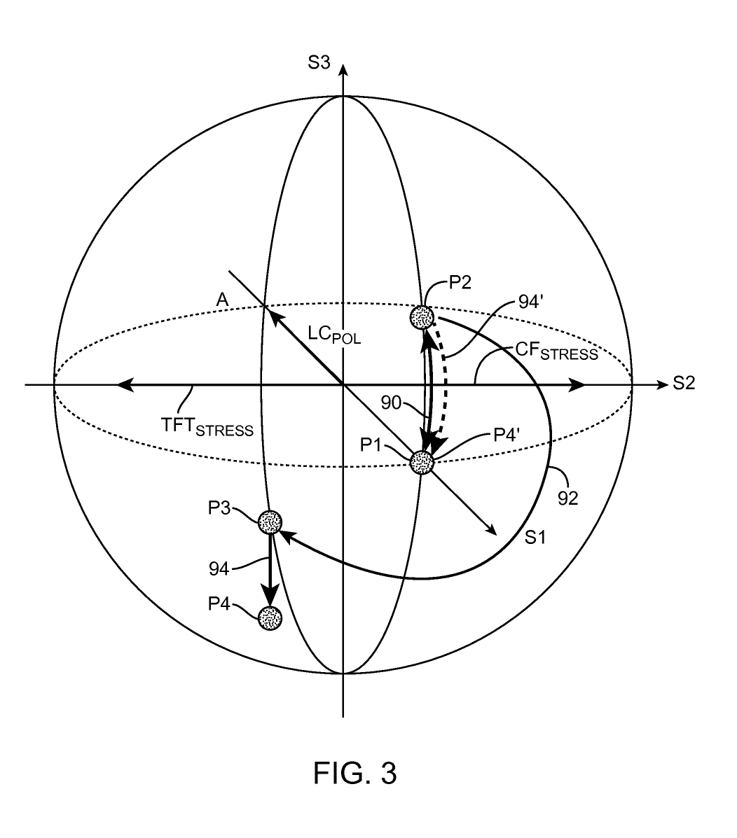

FIG. 3 is a Poincare diagram illustrating one suitable model that may help explain the way that photo-elastic materials in display substrates may contribute to light leakage in an LCD display that is under stress. This model can help explain how light leakage may be reduced, for any amount of stress on the display, by providing the display with a thin-film transistor substrate and/or a color filter substrate with a low photo-elastic constant.

In the model illustrated in FIG. 3, induced birefringence effects in display substrates having a relatively high photo-elastic constant generate polarization changes in light that is passing through the substrates. These polarization changes may allow some of that light to leak out from the display even if liquid crystals in the display are arranged to block the light from escaping from the display. Light leakage may therefore be reduced by providing the display with transparent substrates that exhibit low levels of birefringence under stress.

Using this model to explain light leakage from a display under stress, it can be shown that light leakage may depend more heavily on induced birefringence in a rear side substrate such as a thin-film transistor substrate than on induced birefringence in a front side substrate such as a color filter substrate. This is because a change in the polarization of light that has passed through a birefringent substrate can be exaggerated by light retardation (i.e., an increased path length for the light) as the light subsequently passes through liquid crystal material.

In the Poincare diagram of FIG. 3, polarization states P1, P2, P3, and P4, represent possible polarization states of light passing through display layers in a conventional display having a TFT glass layer and a CF glass layer with relatively high photo-elastic constants. Polarization rotations 90, 92, and 94 represent changes in the polarization of the light as it passes through the TFT glass layer, a liquid crystal layer, and the CF glass layer respectively. In the example of FIG. 3, the TFT glass experiences a first stress TFTₛₜᵣₑₛₛ that is perpendicular to a second stress CFₛₜᵣₑₛₛ in the color filter glass (note that angles in a Poincare diagram are twice that of angles in real systems because a 180 degree rotation of polarization has no physical effect). However, this is merely illustrative, display glass layers may experience stresses in any dimension.

As shown in FIG. 3, light passing though a display may be provided with an initial polarization P1 that is perpendicular to the orientation LCₚₒₗ of liquid crystals in the liquid crystal layer of the display. In the example of FIG. 3, initial polarization P1 is aligned with the S1 axis of the Poincare diagram. In this example, birefringence in the conventional TFT substrate rotates the polarization of a portion of the light in direction 90 to a new polarization angle P2. Light retardation in the liquid crystal material may then further rotate the polarization from P2 to P3 in direction 92.

Because light retardation by the liquid crystal material rotates the polarization around the direction of orientation LCₚₒₗ of the liquid crystals, the magnitude of rotation 92 directly depends on the magnitude of rotation 90 away from initial polarization P1. In a display such as display 14 having a TFT substrate such as TFT substrate 72 having a low photo-elastic constant, rotation 90 may therefore be minimized, thereby reducing or eliminating the effect on polarization of light retardation in a liquid crystal material such as liquid crystal material 60.

If desired, light leakage from display 14 when display 14 is under stress may therefore be reduced by providing display 14 with a TFT substrate having a low photo-elastic constant and a color filter substrate having any suitable photo-elastic constant. However, this is merely illustrative. If desired, light leakage from display 14 when display 14 is under stress may be further reduced by providing display 14 with a TFT substrate having low photo-elastic constant and a CF substrate having a low photo-elastic constant.

As shown in FIG. 3, birefringence in a conventional CF glass layer having a relatively high photo-elastic constant may generate a further polarization rotation in direction 94 from polarization P3 to polarization P4. As indicated by dashed arrow 94′ and polarization P4′, rotation 94 may be substantially equal in magnitude and opposite in direction to rotation 90 if the CF glass layer and the TFT glass layer have a common thickness and a common photo-elastic constant. In the model illustrated by FIG. 3, light leakage from display 14 is proportional to the difference in polarization between initial polarization P1 and final polarization P4.

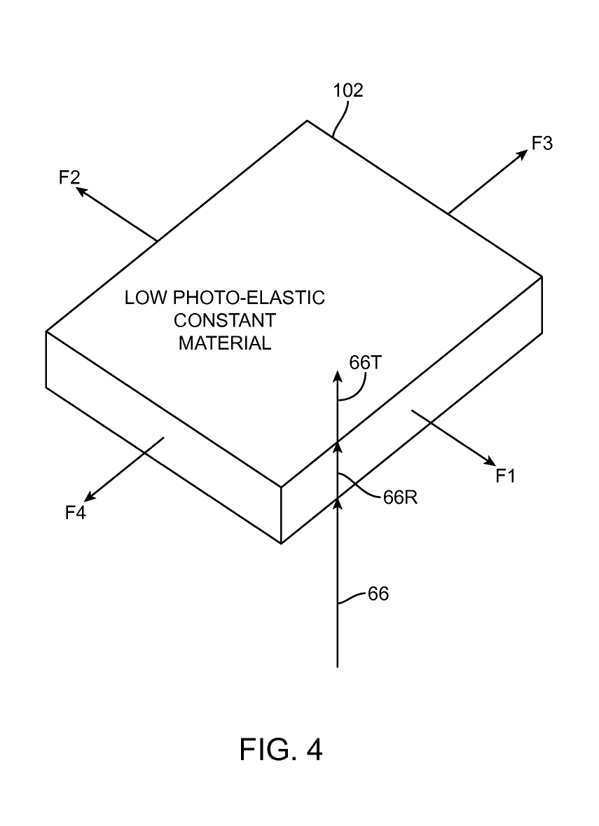

Light leakage from display 14 may therefore be minimized by forming TFT substrate 72 and/or CF substrate 70 from a transparent material such as material 102 of FIG. 4 having a low photo-elastic constant. Transparent material 102 may be a material having a low photo-elastic constant (e.g., less than 3.0×10⁻¹³ cm²/dyn, less than 2.0×10⁻¹³ cm²/dyn, less than 1.0×10⁻¹³ cm²/dyn, less than 0.5×10⁻¹³ cm²/dyn, less than 0.3×10⁻¹³ cm²/dyn, less than 0.2×10⁻¹³ cm²/dyn, between 0.1×10⁻¹³ cm²/dyn and 0.3×10⁻¹³ cm²/dyn, between 0.05×10⁻¹³ cm²/dyn and 0.3×10⁻¹³ cm²/dyn, between 0.05×10⁻¹³ cm²/dyn and 0.5×10⁻¹³ cm²/dyn or between 0.09×10⁻¹³ cm²/dyn and 0.3×10⁻¹³ cm²/dyn) and an average index of refraction (e.g., at a wavelength at or near 589.3 nanometers) of between 1.45 and 1.6, between 1.48 and 1.52, between 1.49 and 1.51 or between 1.3 and 1.8.

As shown in FIG. 4, material 102 (e.g., a glass substrate, a polymer substrate, a plastic substrate, or a substrate of any combination of these materials or other suitable materials) having a low photo-elastic constant may pass incident light such as light 66. A material such as material 102 that is mounted in a display (e.g., a material that is used as a TFT substrate or a CF substrate) may experience one or more forces that may be decomposed along principal directions such as forces F1, F2, F3, and F4 (e.g., due to mounting structures or internal display structures coupled to material 102 in an electronic device). Light 66 may pass into material 102 such that substantially all of refracted portion 66R of light 66 passes through substrate 102 in a common direction and without rotation of the polarization of light 66 even in the presence of forces F1, F2, F3, and F4.

For example, forces F1 and F2 may generate a stress σ₁₁ and force F3 and F4 may generate a perpendicular stress σ₂₂ on material 102 that is different from stress σ₁₁. The induced birefringence in material 102 can be calculated using the photo-elastic constant C of material 102 and equation 1. Because the photo-elastic constant C of material 102 is low, transmitted portion 66T of light 66 may have a polarization that is substantially the same as the polarization of incident light 66. Material 102 may be used to form TFT substrate 72 and/or CF substrate 70 of display 14 of FIG. 2.

In configurations such as the illustrative configuration of FIG. 2 in which TFT substrate 72 and/or CF substrate 70 of display 14 are formed from material having a low photo-elastic constant (e.g., less than 3.0×10⁻¹³ cm²/dyn) light leakage from display 14 will generally be minimized.

The foregoing is merely illustrative of the principles of this invention and various modifications can be made by those skilled in the art without departing from the scope and spirit of the invention. The foregoing embodiments may be implemented individually or in any combination.

What is claimed is:

1. A display, comprising:
a transparent substrate;
an array of thin-film transistors on the transparent substrate;
a color filter layer; and
a liquid crystal layer interposed between the color filter layer and the transparent substrate, wherein the transparent substrate is formed from a transparent material having a photo-elastic constant configured to minimize light leakage from the display when the transparent substrate is flexed.

2. The display defined in claim 1 wherein the color filter layer comprises an additional transparent substrate.

3. The display defined in claim 2 wherein the color filter layer further comprises color filter elements formed on an interior surface of the additional transparent substrate.

4. The display defined in claim 3, further comprising first and second polarizers, wherein the transparent substrate and the color filter layer are interposed between the first and second polarizers.

5. The display defined in claim 4, further comprising backlight structures that emit light through the first and second polarizers, the transparent substrate, the color filter layer, and at least a portion of the liquid crystal layer.

6. The display defined in claim 1 wherein the photo-elastic constant of the transparent material is less than 3.0×10⁻¹³ cm²/dyn.

7. The display defined in claim 6, further comprising backlight structures that emit light through the transparent material.

8. A display, comprising:
a first transparent substrate having a first thickness;
an array of thin-film transistors on the first transparent substrate;
a second transparent substrate having a second thickness; and
an array of color filter elements on the second transparent substrate, wherein the first thickness is smaller than the second thickness.

9. The display defined in claim 8 wherein the first thickness less than half of the second thickness.

10. The display defined in claim 8 wherein the first thickness is less than 0.3 mm.

11. The display defined in claim 8 wherein the first transparent substrate is formed from a transparent material having a photo-elastic constant configured to minimize light leakage when the transparent substrate is flexed.

12. The display defined in claim 11 wherein the photo-elastic constant of the first transparent substrate is less than 3.0×10⁻¹³ cm²/dyn.

13. The display defined in claim 12 wherein the first thickness less than half of the second thickness.

14. A display, comprising:
a color filter substrate;
a thin-film transistor substrate; and
a layer of liquid crystal material interposed between the color filter substrate and the thin-film transistor substrate, wherein the color filter substrate and the thin-film transistor substrate are each formed from a transparent material having a photo-elastic constant configured to minimize light leakage when pressure is applied to a portion of the display.

15. The display defined in claim 14, further comprising backlight structures that generate light for the display.

16. The display defined in claim 15, further comprising a light polarizing layer interposed between the backlight structures and the thin-film transistor substrate.

17. The display defined in claim 16, further comprising at least one spacer structure in the layer of liquid crystal material, wherein the portion of the display is adjacent to the at least one spacer structure.

18. The display defined in claim 14, further comprising a first polarizer layer attached to the thin-film transistor substrate and a second polarizer layer attached to the color filter substrate.

19. The display defined in claim 14, wherein the photo-elastic constant of the color filter substrate is less than 3.0×10⁻¹³ cm²/dyn.

20. The display defined in claim 19, wherein the photo-elastic constant of the thin-film transistor substrate is less than 3.0×10⁻¹³ cm²/dyn.
